(19) United States
(12) Patent Application Publication
(10) Pub. No.: US 2009/0276182 A1
(43) Pub. Date: Nov. 5, 2009

(54) MACHINE FAULT DETECTION METHOD

(75) Inventors: YI FENG LEE, TAIPEI COUNTY (TW); CHUN CHI CHEN, TAIPEI CITY (TW); YUN-ZONG TIAN, TAICHUNG COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/140,584

(22) Filed: Jun. 17, 2008

(30) Foreign Application Priority Data
May 2, 2008 (TW) 97116215

(51) Int. Cl. G06F 17/18; G06F 15/00

(52) U.S. Cl. 702/179; 702/182

(57) ABSTRACT

A machine fault detection method is applied to a plurality of machines. The machines are used for processing at least one wafer-in-process (WIP). The method includes the flowing steps. A statistical database of the wafer-in-process is provided. An association rules is used to search and survey the statistical database in order to calculate a support degree and a reliability degree. A threshold is selected to determine whether the support degree and the reliability degree have surpassed the threshold or not. When the support degree and the reliability degree have surpassed the threshold, a root cause error in the statistical database corresponded by the support degree and the reliability degree is determined. When the support degree and the reliability degree have not surpassed the threshold, the above steps are repeated.

### BACKGROUND OF THE INVENTION

1. Field of the Invention

The present invention relates to a machine fault detection method. In particular, the present invention relates to a machine fault detection method that detects the root cause error generated from a plurality of machines used for processing wafer-in-process (WIP).

2. Description of the Related Art

The yield rate is a key index for the semiconductor fabricator. The yield rate represents the fabrication level and specification of the semiconductor fabricator. Furthermore, the yield rate also relates to the fabrication cost of the semiconductor fabricator. The yield rate affects the whole profit margin of the semiconductor fabricator. Therefore, how to improve the yield rate is of utmost concern for the semiconductor fabricator.

In the semiconductor fabrication industry, the wafer-in-process (WIP) must be processed by a plurality of semiconductor machines and a plurality of fabrication processes, such as chemical deposition, ion injection, mask, grind, etc. The fabrication process will affect the quality of the wafer-in-process. For example, the electrical quality and the status of the semiconductor fabrication machine determine the yield rate of the wafer-in-process. Therefore, if an abnormal condition can be detected in advance, the problem cab be solved early and the fabrication cost resulted from reduced yield rate can be kept down.

The methods for checking and measuring the yield rate of the wafer-in-process have been developed. For example, Taiwan patent TW 1229915 discloses a method for analyzing the equipment correlation of the yield rate of the semiconductor fabrication machine, a system thereof, a semiconductor fabrication method thereof, and a storage medium for storing the computer program of executing the method. Reference is made to FIG. 1, which shows the method for analyzing the equipment correlation of the yield rate of the semiconductor fabrication machine. The method uses a computer program to execute the following steps. A semiconductor fabrication process application program is used to select the data of the yield rate of at least one wafer (S100). The frequency of the wafer being processed by a semiconductor fabrication machine is calculated (S110). The frequency figure is used for analyzing the yield rate affected by the semiconductor fabrication machine (S120). According to the data of the yield rate, a P check value is generated (S130). The P check value is used for analyzing the yield rate affected by the semiconductor fabrication machine (S140). According to a percentage limitation value, a high percentage set and a low percentage set are generated (S150). The high percentage set and the low percentage set are calculated to generate an abnormal analysis result (S160). The abnormal analysis result is compared with an abnormal threshold to determine whether the semiconductor fabrication machine is abnormal or not (S170). According to the analysis result, the abnormal semiconductor fabrication machine is checked (S180). The semiconductor fabrication machine is adjusted and is again used for fabrication a semiconductor product (S190).

However, the method of using the equipment correlation of the prior art can only be used to check the yield rate of a single semiconductor fabrication machine, or find out the relation between the yield rate or measurement values against a plurality of semiconductor fabrication machines in a single fabrication process. The method cannot analyze the yield rate affected by a plurality of semiconductor fabrication machines in a plurality of fabrication processes. The method cannot find out the semiconductor fabrication machine that will affect the yield rate in the plurality of fabrication processes.

### SUMMARY OF THE INVENTION

One particular aspect of the present invention is to provide a machine fault detection method. The method uses association rules to find out the root cause error from a plurality of semiconductor fabrication machines, the yield rate is improved, the fabrication cost is reduced, and the machine can be efficiently monitored.

The machine fault detection method is applied to a plurality of semiconductor fabrication machines. The semiconductor fabrication machines are used for processing at least one wafer-in-process (WIP). The method includes the flowing steps. A statistical database of the wafer-in-process is provided. An association survey calculation is performed to generate a support degree and a reliability degree. A threshold is selected. Whether the support degree and the reliability degree have surpassed the threshold or not is determined. When the support degree and the reliability degree have surpassed the threshold, a root cause error in the statistical database corresponded by the support degree and the reliability degree is determined. When the support degree and the reliability degree have not surpassed the threshold, the above steps are repeated.

The present invention uses the association rules in the statistical database, and has the following characteristics.

1. The root cause error of one or one set of semiconductor fabrication machines that cause the wafer-in-process being damaged is found to improve the yield rate, reduce the fabrication cost, and monitor the machines efficiently.

2. The threshold is determined (either by a user or by a computer) to find the root cause error of one or one set of semiconductor fabrication machines that cause the wafer-in-process being damaged. Thereby, the yield rate is improved, the fabrication cost is reduced, and the machine is efficiently monitored.

3. The machine default in the semiconductor fabrication processes can be detected efficiently to lower the risk. The potential risk is prevented and the safety is guaranteed.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a flow chart of the analysis method of the yield rate of the semiconductor fabrication machines of the prior art;

FIG. 2 is a flow chart of the machine fault detection method of the present invention;

FIG. 3 is a schematic diagram of the association rules of the present invention;

FIG. 4 is a second schematic diagram of the association rules of the present invention;

FIG. 5 is a first schematic diagram of the association rules of the present invention;

FIG. 6 is a schematic diagram of the system structure of the machine fault detection method of the present invention; and

FIG. 7 is a schematic diagram of the image on computer display screen of the present image.

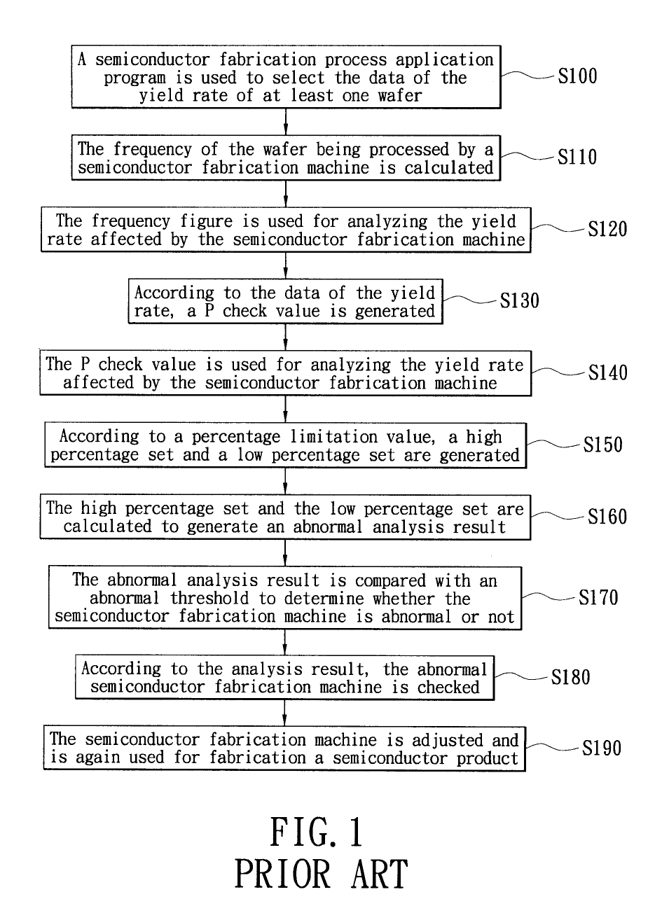

### DETAILED DESCRIPTION OF THE PREFERRED EMBODIMENTS

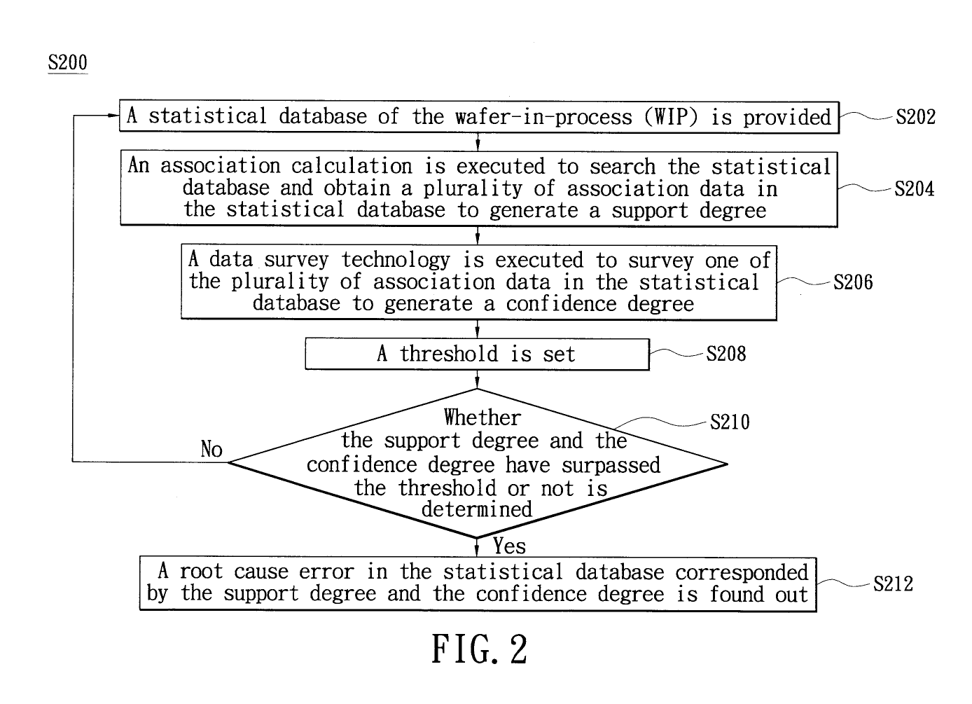

Reference is made to FIG. 2, which shows the machine fault detection method S200 of the present invention. The machine fault detection method S200 is applied to a plurality of semiconductor fabrication machines. The semiconductor fabrication machines are used for processing at least one wafer-in-process (WIP). The method S200 includes the flowing steps, including S202, S204, S206, S208, S210, and S212.

The semiconductor fabrication machines are formed by one or more dry etch machines, oven tube machines, thin-film deposition machines, and sputtering machines, etc. The dry etch machines are used for etching the polycrystalline, etching the oxidized layer, and etching the metal layer. The furnace tube machines are used for depositing the polycrystalline, and depositing the SiO₂. The thin-film deposition machines are used for oxidizing the silicon nitride, strengthening the silicon nitride by plasma, strengthening the silicon nitride by penetrating UV rays, and strengthening SiO₂, phosphorus glass, and boron phosphorus glass by plasma. The sputtering machines are used for metal-sputter.

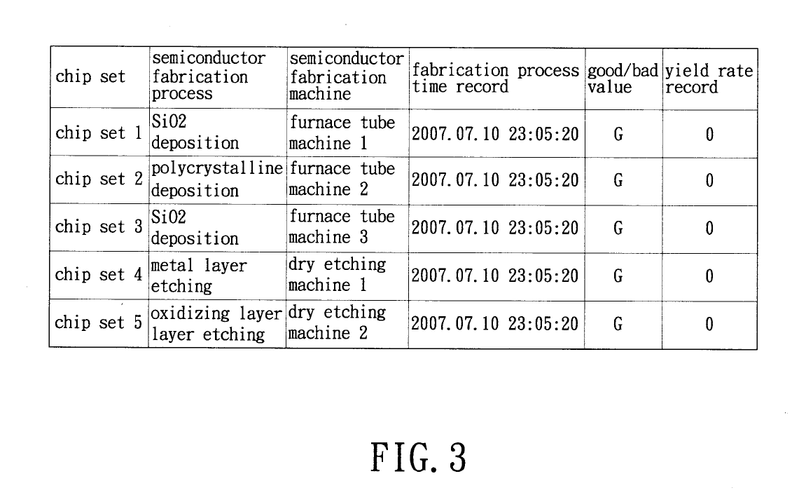

Step S202 is executed. A statistical database of the wafer-in-process is provided. The statistical database records a plurality of fabrication process parameters of the semiconductor fabrication machines for the wafer-in-process. Reference is made to FIG. 3. The statistical database includes a plurality of data which are of a plurality of chip sets, a plurality of semiconductor fabrication processes, a plurality of semiconductor fabrication machines, a plurality of fabrication process time records, a good/bad value, and a plurality of yield rate records. According to the statistical database, the association and data searching technology are used for finding a semiconductor fabrication process or the semiconductor fabrication machine that caused a reduction in the yield rate and caused the generating of the bad value.

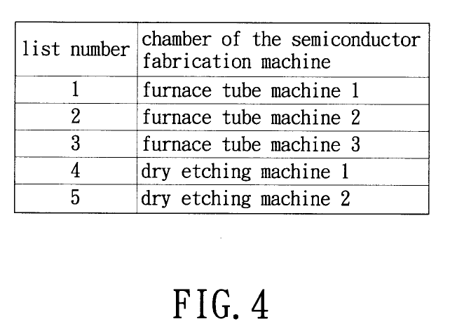

Step S204 is executed. The chamber of the plurality of semiconductor fabrication machines for processing the wafer-in-process is labeled and listed (referencing to FIG. 4), and is transferred to the statistical database. Next, an association rules (also named as a market basket analysis or an association calculation, wherein the association calculation is part of the association survey calculation) is used for searching the statistical database to obtain a plurality of association data in the statistical database. The association data in the statistical database (such as the collection set of the semiconductor fabrication machines) is calculated by the association rules to generate a support degree corresponded by the statistical database. The support degree represents a ratio of the collection set in the statistical database (i.e. the support degree is a ratio formed by one of the plurality of association data against the plurality of association data in the statistical database).

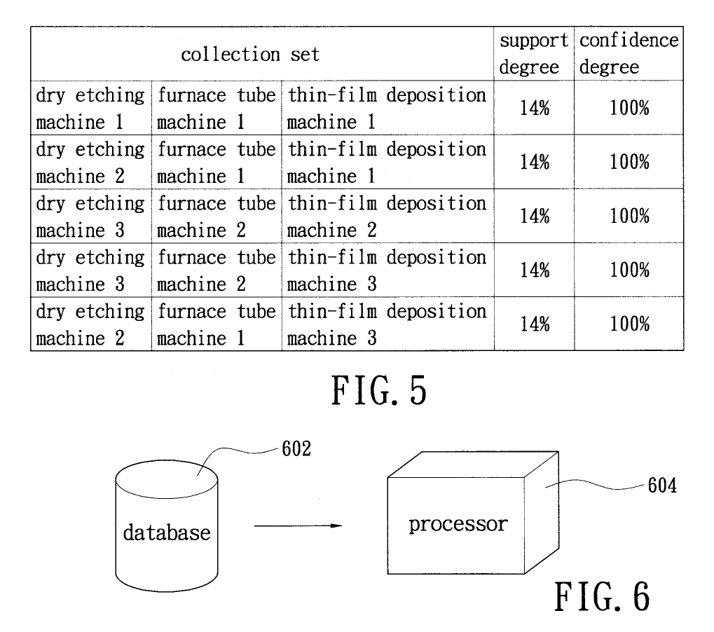

Step S206 is executed. A data survey technology is executed (the data survey technology is also part of the association survey calculation). The data survey technology surveys the association data in the statistical database to generate a confidence degree. The reliability degree represents the ratio of the appeared collection set in the statistical database (i.e. the reliability degree is a ratio formed by the appeared plurality of association data against the plurality of association data in the statistical database.), referencing to FIG. 5 for appeared collection set.

Step S208 is executed. A threshold is set. The threshold can be set by the user or the computer.

Step S210 is executed. Whether the support degree and the reliability degree have surpassed the threshold or not is determined. When the support degree and the reliability degree have surpassed the threshold, a next step is executed. When the support degree and the reliability degree have not surpass the threshold, the step S202 is repeated.

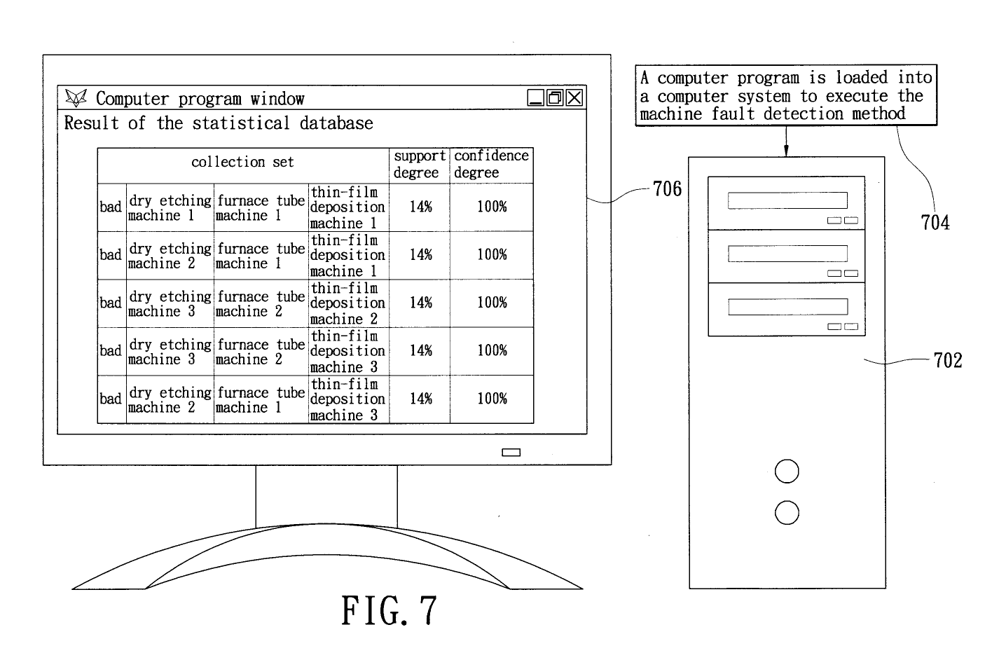

Step S212 is executed. A root cause error in the statistical database corresponded by the support degree and the reliability degree is determined. The root cause error is the machine fault (i.e. the root cause error shows a particular machine or particular set of machines that is at fault; thereby the responsible the one or one set of machines can be traced according to the root cause error. Please see computer display screen 706 of FIG. 7 for an example.).

Reference is made to FIG. 6, which shows a schematic diagram of the system structure of the machine fault detection method of the present invention. The system structure includes a database 602 and a central processing unit (CPU) 604. The database 602 is the statistical database that records the data of the wafer-in-process processed by the semiconductor fabrication machines. The central processing unit 604 performs the association rules to calculate and obtain the support degree and the reliability degree corresponded by the database 602.

Reference is made to FIG. 7. A computer system 702, a software interface 704, and a computer display screen 706 are included. The software interface 704 is a computer program and is loaded into the computer system 702, and the software interface 704 executes the machine fault detection method. The calculation result is transmitted and is displayed on the computer display screen 706. The computer display screen 706 is the result of the statistical database, which shows the root cause error (i.e. the one or one set of machines that is at fault) when the semiconductor fabrication machines (i.e. the dry etch machines, the furnace tube machines, the thin-film deposition machines, and the sputtering machines) process the wafer-in-process.

The present invention uses the association rules in the statistical database, and has the following characteristics.

1. The root cause error of one or one set of semiconductor fabrication machines that cause the wafer-in-process being damaged is found.

2. The threshold is determined (either by a user or a computer) to find the root cause error of one or one set of semiconductor fabrication machines that cause the wafer-in-process to suffer defect which leads to lower wafer fabrication yield rate.

3. The machine default in the semiconductor fabrication processes can be detected efficiently to lower the risk. The yield rate is improved, the fabrication cost is reduced, the machine is efficiently monitored, and the potential risk is prevented and the safety is guaranteed.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A machine fault detection method, applied to a plurality of machines and the machines are used for processing at least one wafer-in-process (WIP), comprising:
providing a statistical database of the wafer-in-process;
performing an association survey calculation to generate a support degree and a confidence degree;
setting a threshold; and
determining whether the support degree and the confidence degree have surpassed the threshold or not, wherein when the support degree and the confidence degree have surpassed the threshold, a root cause error in the statistical database corresponded by the support degree and the reliability degree is determined, and when the support degree and the reliability degree have not surpass the threshold, the above steps are repeated.

2. The machine fault detection method as claimed in claim 1, wherein the machines are semiconductor fabrication machines.

3. The machine fault detection method as claimed in claim 2, wherein the semiconductor fabrication machines are dry etch machines, furnace tube machines, thin-film deposition machines, and sputtering machines.

4. The machine fault detection method as claimed in claim 1, wherein the statistical database includes a plurality of data, the plurality of data are of a plurality of chip sets, a plurality of semiconductor fabrication processes, a plurality of semiconductor fabrication machines, a plurality of fabrication process time records, a plurality of good/bad values, and a plurality of records of yield rate.

5. The machine fault detection method as claimed in claim 1, wherein the association survey calculation further comprises an association calculation and a data survey technology.

6. The machine fault detection method as claimed in claim 5, wherein the association calculation is to search the statistical database to obtain a plurality of association data of the statistical database.

7. The machine fault detection method as claimed in claim 5, wherein the data survey technology is to survey one of the plurality of association data of the statistical database.

8. The machine fault detection method as claimed in claim 7, wherein the support degree is a ratio formed by one of the plurality of association data against the plurality of association data in the statistical database.

9. The machine fault detection method as claimed in claim 1, wherein the confidence degree is a ratio formed by the appeared plurality of association data against the plurality of association data in the statistical database.

10. A machine fault detection method, applied to a plurality of machines and the machines are used for processing at least one wafer-in-process, comprising:
providing a statistical database of the wafer-in-process, wherein the statistical database records a plurality of fabrication process parameters corresponding to the machines;
performing an association calculation to search the statistical database to obtain a plurality of association data and generate a support degree;
executing a data survey technology to survey one of the plurality of association data in the statistical database to generate a reliability degree;
finding out a root cause error in the statistical database corresponded by the support degree and the confidence degree; and
repeating the above steps when the root cause error is not found.

11. The machine fault detection method as claimed in claim 10, the association rules further comprises a step of setting a threshold to determine whether the support degree and the confidence degree have surpassed the threshold or not.

12. The machine fault detection method as claimed in claim 10, wherein the machines are semiconductor fabrication machines.

13. The machine fault detection method as claimed in claim 10, wherein the semiconductor fabrication machines are dry etch machines, oven tube machines, thin-film deposition machines, and sputtering machines.

14. The machine fault detection method as claimed in claim 10, wherein the fabrication process parameters includes a plurality of data, the plurality of data are of a plurality of chip sets, a plurality of semiconductor fabrication processes, a plurality of semiconductor fabrication machines, a plurality of fabrication process time records, a plurality of good/bad values, and a plurality of records of yield rate.

15. The machine fault detection method as claimed in claim 10, wherein the support degree is a ratio formed by one of the plurality of association data against the plurality of association data in the statistical database.

16. The machine fault detection method as claimed in claim 10, wherein the confidence degree is a ratio formed by the appeared plurality of association data against the plurality of association data in the statistical database.
